(19) United States
(12) Patent Application Publication
(10) Pub. No.: US 2006/0067534 A1
(43) Pub. Date: Mar. 30, 2006

(54) Storage medium storing stereo enhancement processing program, stereo enhancement apparatus and stereo enhancement method

(75) Inventors: Masato Mizuta, Kyoto (JP); Yasushi Ida, Kyoto (JP); Koji Kondo, Kyoto (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/157,978

(22) Filed: Jun. 22, 2005

(30) Foreign Application Priority Data
Sep. 27, 2004 (JP) 2004-279088

(51) Int. Cl. H04R 5/00; H04B 1/00

(52) U.S. Cl. 381/1; 381/119

(57) ABSTRACT

A game apparatus functioning as a stereo enhancement apparatus includes a CPU, and the CPU generates sound signals of stereo sounds required for the game. The CPU adjusts volumes of stereo sounds simultaneously played from respective sound sources on the basis of pan of the respective sound sources, and mixes the plurality of stereo sounds whose volumes have been adjusted to generate a stereo sound of two channels. Next, the stereo sound including an L channel sound signal (Lin) and an R channel sound signal (Rin) that have been mixed is divided into two systems, and then, a stereo enhancement signal (Lin−Rin) is generated. Then, the stereo enhancement signal is delayed, an added signal obtained by adding the delayed stereo enhancement signal to the Lin is generated, and a subtracted signal obtained by subtracting the delayed stereo enhancement signal from the Rin is generated. Then, the added signal is output from a speaker for L channel, and the subtracted signal is output from a speaker for R channel.

### BACKGROUND OF THE INVENTION

1. Field of the Invention

The present invention relates to a storage medium storing a stereo enhancement processing program, a stereo enhancement apparatus, and a stereo enhancement method. More specifically, the present invention relates to a storage medium storing stereo enhancement processing program, a stereo enhancement apparatus, and a stereo enhancement method that simultaneously reproduce a plurality of stereo sounds output from a plurality of sound sources.

2. Description of the Prior Art

Conventionally, in a case of less a feeling of stereo such as a narrow arrangement space between stereo speakers, the method of enhancing sound of two channels includes crosstalk cancel between the two speakers. However, it has been known that the crosstalk cancel causes substantial decrease in sound quality of a sound whose sound is positioned at an approximately center. A method of solving such a problem is disclosed in Japanese Patent No. 3074813 [H04S 1/00, G10H 1/00, H04S 7/00] registered on Jun. 9, 2000 (document 1) and WO94/16538 (document 2) internationally published on Jul. 21, 1994.

In the document 1, a method that has conventionally been know as a crosstalk cancel method is utilized, and a circuit in which a sound positioned at the center is not subjected to the crosstalk cancel is disclosed. By applying the circuit to each of a plurality of tones, a stereo output with sound enhanced is obtained.

Furthermore, according to the document 2, a stereo sound signal (left signal and right signal) is input, and a signal obtained from a difference between the left signal and the right signal is subjected to a filter process. A delay signal through the filter process is added to one of the stereo sound signal, and is subtracted from the other of the stereo sound signal. Thus, the sound output with sound enhanced is obtained.

However, since the crosstalk cancel process is performed on each of the plurality of tones (sound sources) in the document 1, in order to perform the process by the software, the process is required by the number of the sound sources, resulting in increase of the processing loads.

In addition, in the document 2, a detailed technique for obtaining more preferable stereo enhancement effect than the crosstalk cancel is disclosed, and can be called as a stereo enhancement effector apparatus. Accordingly, direct application of this technique to the game apparatus intended for obtaining a stereo effect for augmenting a scene of the game rather than precisely playing audio frequencies such as reality for an original sound, etc. is not preferable in view of processing cost. Furthermore, a delay process depending on frequencies causes a need for a filtering process, and increases processing loads. In addition, the game apparatuses, due to a relatively narrow space between the right and the left speakers, still has a problem that, as the further the pan is away from the center, the larger the volume is in directly application of the technique.

### SUMMARY OF THE INVENTION

Therefore, it is a primary object of the present invention to provide a novel storage medium storing a stereo enhancement processing program, stereo enhancement apparatus, and stereo enhancement method.

Another object of the present invention is to provide a storage medium storing a stereo enhancement processing program, a stereo enhancement apparatus, and a stereo enhancement method that can decrease processing loads.

The other object of the present invention is to provide a storage medium storing a stereo enhancement processing program, a stereo enhancement apparatus, and a stereo enhancement method that provide in a simple manner a feeling of stereo even in a narrow arrangement space of speakers.

A storage medium storing a stereo enhancement processing program according to the present invention causes a stereo sound playing apparatus provided with a plurality of sound sources for respectively generating a plurality of stereo sounds to be simultaneously played and speakers for outputting a stereo sound to function as a stereo enhancement apparatus. The stereo enhancement processing program causes a processor of the stereo enhancement apparatus to execute a pan setting step, a volume adjusting step, a mixing step, and a stereo enhancement step. The pan setting step sets pan of sound by adjusting a balance between the right and the left as to respective one of the plurality of stereo sounds. The volume adjusting step adjusts volumes of the stereo sounds output from the sound sources on the basis of the pan set by the pan setting step. The mixing step mixes the plurality of stereo sounds whose volumes have been adjusted by the volume adjusting step to make a stereo output of two channels. And, the stereo enhancement step enhances a sound of the stereo output which has been mixed by the mixing step.

More specifically, the stereo sound playing apparatus (10: a reference numeral corresponding in the “preferred embodiment” described later and so forth) is provided with the plurality of sound sources for respectively generating the plurality of stereo sounds to be simultaneously played and the speakers (34L, 34R) for outputting a stereo sound. The stereo sound playing apparatus (10) functions as the stereo enhancement apparatus by causing the processor to execute the stereo enhancement processing program. The pan setting step sets the pan of the sounds by adjusting a balance between the right and the left as to respective one of the plurality of stereo sounds. The volume adjusting step (S13, S15) adjusts the volumes of the stereo sounds output from the sound sources on the basis of the pan set by the pan setting step. The mixing step (S3) mixes the plurality of stereo sounds whose volumes have been adjusted by the volume adjusting step (S13, S15) to make the stereo output of two channels. That is, the plurality of stereo sounds are brought together into one stereo sound. The stereo enhancement step (S5) enhances the sound of the stereo output which has been mixed by the mixing step (S3).

According to the present invention, since the sound of one stereo sound generated by mixing the plurality of stereo sounds output from the sound sources is enhanced, it is possible to substantially reduce processing loads in comparison with enhancing each of those sounds of the stereo sounds.

Furthermore, since the volumes of the plurality of stereo sounds output from the plurality of sound sources are adjusted on the basis of the pan, no variations of the volumes of the respective stereo sounds due to the enhancement of the sound, etc. occurs, causing no uncomfortable feeling at the stereo sound to be output.

In one embodiment of the present invention, the stereo enhancement step includes a stereo enhancement signal generating step of generating a stereo enhancement signal by subtracting a sound signal of one channel from a sound signal of the other channel out of the stereo output by the mixing step, a delaying step of generating a delay stereo enhancement signal obtained by delaying the stereo enhancement signal, an adding step of generating an added signal by adding the delay stereo enhancement signal to the sound signal of the other channel, a subtracting step of generating an subtracted signal obtained by subtracting the delay stereo enhancement signal from the sound signal of the one channel, and a sound outputting step of making a sound output by taking the added signal as the stereo output of the one channel and the subtracted signal as the stereo output of the other channel. More specifically, the stereo enhancement step (S5) includes the stereo enhancement signal generating step (S23), the delaying step (S25), the adding step (S27), the subtracting step (S29), and the sound outputting step (S31). The stereo enhancement signal generating step (S23) generates the stereo enhancement signal by subtracting the sound signal of the one channel from the sound signal of the other channel out of the stereo output by the mixing step (S3). The delaying step (S25) generates the delay stereo enhancement signal obtained by delaying the stereo enhancement signal. The adding step (S27) generates the added signal by adding the delay stereo enhancement signal to the sound signal of the other channel (from which the sound signal of the one channel is subtracted). The subtracting step (S29) generates the subtracted signal by subtracting the delay stereo enhancement signal from the sound signal of the one channel (that has been subtracted). The sound outputting step (S31) makes the sound output by taking the added signal as the stereo output of the one channel and the subtracted signal as the stereo output of the other channel. That is, the stereo enhancement signal obtained by subtracting the sound signal of one channel from the sound signal of the other channel out of the stereo output that has been mixed is generated, and the sound whose sound is positioned at approximately the center is not used for the stereo enhancement, and therefore, it is possible to prevent sound quality of the sound whose sound is positioned at approximately the center from being decreased.

In another embodiment of this invention, the volume adjusting step does not adjust the volume of the stereo sound when the pan of the sound of the stereo sound output from the sound source exists within a fixed range including a center, and adjusts, when the pan of the sound of the stereo sound output from the sound source exists outside the fixed range, the volume of the stereo sound such that the volume is lowered as it is away from the fixed range. More specifically, the volume adjusting step (S13, S15) does not adjust the volume of the stereo sound when the pan of the sound of the stereo sound output from the sound source exists within the fixed range including the center (S13), and adjusts, when the pan of the sound of the stereo sound output from the sound source exists outside the fixed range, the volume of the stereo sound such that the volume is lowered as it is away from the fixed range (S15). Thus, the volume of the stereo sound output from the sound source is adjusted, and therefore, it is possible to mix the stereo sounds having the volumes of the same level. That is, it is possible to eliminate the variations of the stereo sounds to be mixed prior to the stereo enhancement, causing no uncomfortable feeling about the stereo sound to be output.

In another embodiment of the present invention, the volume adjusting step does not adjust the volume of the stereo sound when the pan of the sound of the stereo sound output from the sound source exists at the center, and adjusts, when the pan of the sound of the stereo sound output from the sound source exists in a position except for the center, the volume of the stereo sound such that the volume is lowered as it is away from the center. More specifically, the volume adjusting step (S13, S15) does not adjust the volume of the stereo sound when the pan of the sound of the stereo sound output from the sound source exists at the center, and adjusts, when the pan of the sound of the stereo sound output from the sound source exists in a position except for the center, the volume of the stereo sound such that the volume is lowered as it is away from the center. Thus, it is possible to eliminate unnaturalness of transmission of sound in the ear occurring due to the variations of the stereo sounds to be mixed prior to the enhancement of the sound.

The stereo enhancement apparatus according to this embodiment is provided with sound sources, a pan setting means, a volume adjusting means, a mixing means, and a stereo enhancement means. The sound sources respectively generate a plurality of stereo sounds to be simultaneously played. The pan setting means sets pan of sounds by adjusting a balance between the right and the left as to respective one of the plurality of stereo sounds. The volume adjusting means adjusts volumes of the stereo sounds output from the sound sources on the basis of the pan set by the pan setting means. The mixing means mixes the plurality of stereo sounds whose volumes have been adjusted by the volume adjusting means to make a stereo sound of two channels. And, the stereo enhancement means enhances a sound of the stereo output which has been mixed by the mixing means.

In the invention of the stereo enhancement apparatus, it is possible to substantially decrease processing loads similar to the above-described invention of the storage medium.

The stereo enhancement method according to this invention is a stereo enhancement method of a stereo sound playing apparatus provided with sound sources for respectively generating a plurality of stereo sounds to be simultaneously played and speakers for outputting a stereo sound. The stereo enhancement method comprising following steps of (a) setting pan of sounds by adjusting a balance between the right and the left as to respective one of the plurality of stereo sounds, (b) adjusting volumes of the stereo sounds output from the sound sources on the basis of the pan set by the step (a), (c) mixing the plurality of stereo sounds whose volumes have been adjusted by the step (b) to make a stereo output of two channels; and (d) enhancing a sound of the stereo output which has been mixed by the step (c).

In the invention of the stereo enhancement apparatus, it is possible to substantially decrease processing loads similar to the above-described invention of the storage medium.

The above described objects and other objects, features, aspects and advantages of the present invention will become more apparent from the following detailed description of the present invention when taken in conjunction with the accompanying drawings.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of a game apparatus functioning as a stereo enhancement apparatus of this embodiment;

FIG. 2 is a block diagram showing an electric configuration of the game apparatus shown in FIG. 1;

FIG. 3 is an illustrative view showing a memory map of a WRAM provided in the game apparatus shown in FIG. 2;

FIG. 4 is a circuit diagram showing a functional configuration of a stereo enhancement process of this invention;

FIG. 5 is an illustrative view showing a stereo sound output in a case that a stereo sound whose sound is positioned at the left is input to the circuit shown in FIG. 4;

FIG. 6 is an illustrative view showing a stereo sound output in a case that a stereo sound whose sound is positioned at the center is input to the circuit shown in FIG. 4;

FIG. 7 is an illustrative view showing a graph representing a relationship between a volume of a sound to be output and pan in a case that a sound source is played at a constant volume, and a adjustment graph for adjusting the volume depending on the pan;

FIG. 8 is an illustrative view showing another example of an adjustment graph for adjusting a volume of a sound output through reproduction of the sound source;

FIG. 9 is a flowchart showing a sound playing process of a CPU shown in FIG. 2, and

FIG. 10 is a flowchart showing a stereo enhancement and sound outputting process of the CPU shown in FIG. 2.

### DETAILED DESCRIPTION OF THE PREFERRED EMBODIMENTS

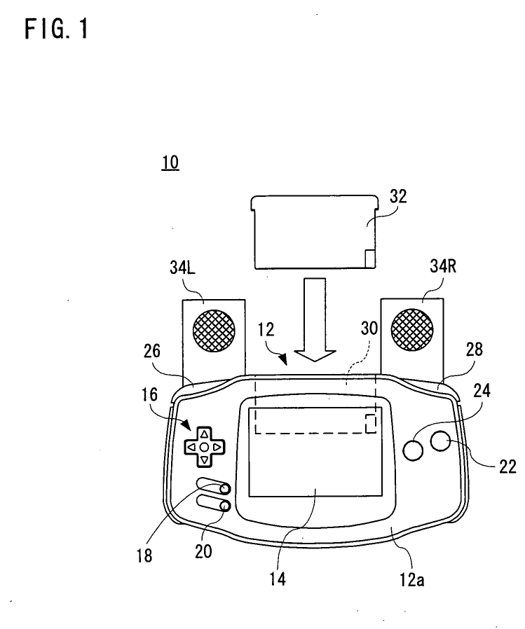

Referring to FIG. 1, one example of a game apparatus 10 being a stereo sound playing apparatus that executes a stereo enhancement processing program of the present invention, and functions as a stereo enhancement apparatus is shown. To such the game apparatus 10, a hand-held type game machine such as GAMEBOY ADVANCE (product name) is applied. The game apparatus 10 has, on the surface of a case 12 thereof, provided with a color liquid crystal display (hereinafter, referred to as “LCD”) 14 at an approximately center. On the LCD 14, a game space and game characters such as a player object, etc. appearing in the game space are displayed, and messages are also displayed as necessary. Also on the surface of the case 12, operating buttons 16, 18, 20, 22, 24, 26, and 28 are provided. The operating buttons 16, 18 and 20 are placed at the left of the LCD 14, and the operating buttons 22 and 24 are placed at the right of the LCD 14. Furthermore, the operating buttons 26 and 28 are placed at an upper end surface (top surface) (above the LCD 14) of the case 12.

The operating button 16 is a cross button which functions as a digital joystick, and is able to instruct a moving direction of the game characters and move a cursor displayed on the LCD 14 by operating any one of four depression portions. The operating button 18 is a start button formed by a push button, and utilized for instructing a start of the game, etc. The operating button 20 is a select button formed by the push button, and utilized for selecting a game mode, etc.

The operating button 22 is an A button formed by the push button, and allows the game character (player object) displayed on the LCD 14 to perform an arbitrary action such as hitting, throwing, holding, jumping, riding, cutting by a sword, talking, etc. The operating button 24 is a B button formed by the push button, and utilized for changing a game mode selected by the select button 20, canceling the action determined by the A button 22, and so forth. The operating button 26 is a left depression button (L button) formed by the push button, and the operating button 28 is a right depression button (R button) formed by the push button. The operating buttons 26 and 28 can perform the same operation as the A button 22 and the B button 24, and also perform a subsidiary operation of the A button 22 and the B button 24.

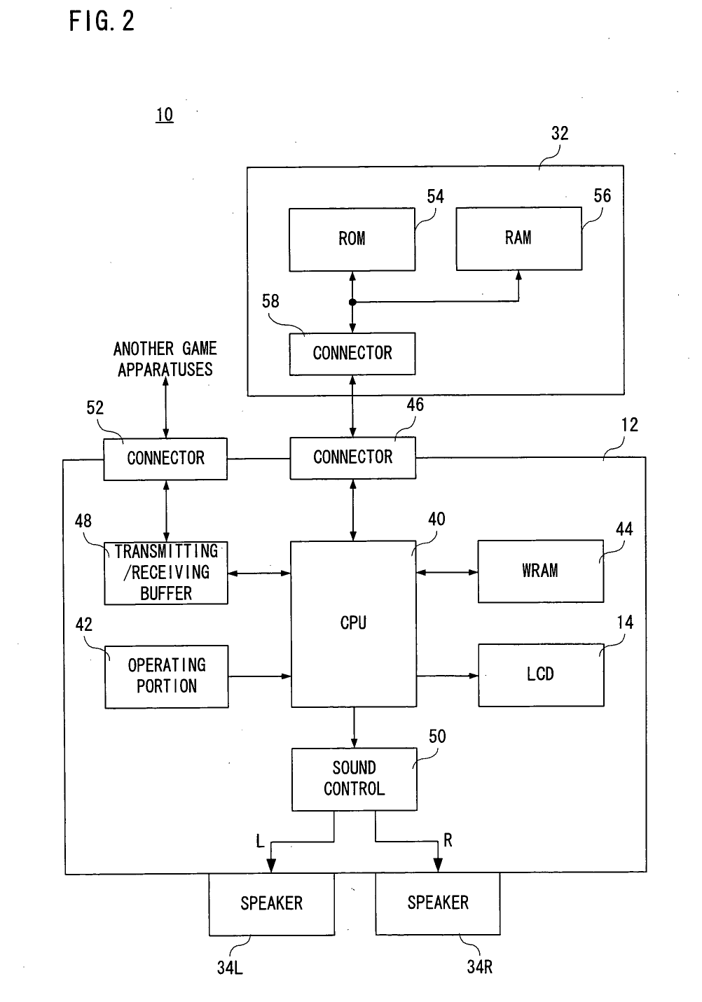

Also, on the rear surface of the case 12 at an upper end, a loading slot 30 is provided. Into the loading slot 30, a game cartridge 32 is loaded. Although not illustrated, connectors are respectively provided at a depth portion of the loading slot 30 and at an end portion of the game cartridge 32 in the loading direction (see FIG. 2), and when the game cartridge 32 is loaded into the loading slot 30, the two connectors are connected with each other. Therefore, the game cartridge 32 is accessible by a CPU 40 (see FIG. 2) of the game apparatus 10.

It is noted that although a game cartridge is utilized in this embodiment, in place of this, various information recording mediums including an optical system information recording medium such as a CD-ROM, a DVD, etc., an optical magnetic disc or magnetic disc, etc can be applied.

Furthermore, speakers 34L and 34R are fixedly provided on a rear surface of the case 12 such that they protrude upward through an upper surface of the case 12. As understood from FIG. 1, the speaker 34L is placed on a rear surface of the operation button 26, and the speaker 34R are placed on a rear surface of the operation button 28. It is noted that the speakers 34L and 34R are provided inside the case 12, and sound holes are formed on the case 12 at positions corresponding to the positions of the speakers. For example, where the start button 18 and the select button 20 are provided above the A button 22 and the B button 24, the speaker 34L can be provided below the cross button 16, and the speaker 34R can be provided blow the A button 22 and the B button 24. These speakers 34L and 34R are for outputting a sound required for the game such as a BGM, a sound or onomatopoeic sound of game characters, etc. during the game. In this embodiment, the speaker 34L outputs a left channel (L channel) voice (sound) of a stereo sound and a right channel (R channel) voice (sound) of a stereo sound.

It is noted that although illustration is omitted, the case 12 is provided with an external expansion connector on its upper surface, a battery accommodating box on its rear surface, and a power switch, a sound volume switch, an earphone jack, etc. on its bottom surface.

An electric configuration of the game apparatus 10 is shown in FIG. 2. With referring to FIG. 2, the game apparatus 10 is provided with the CPU 40 as described above. The CPU 40 is also called a computer or a processor, and entirely controls the game apparatus 10. The CPU 40 or the computer is connected with the above-described LCD 14, an operating portion 42 and a working memory (WRAM) 44 via an internal bus, and also connected with a connector 46, a transmitting/receiving buffer 48, and a sound control circuit 50, etc.

The LCD 14 receives display data from the CPU 40 to display a game image. It is noted that although illustration is omitted, the CPU 40 is connected with, for example, a VRAM, an LCD controller, etc., and under control of the CPU 40, game image data such as background image data, object image data including a player object, etc. are rendered in the VRAM. Then, the LCD controller reads the game image data (display data) rendered in the VRAM according to the instruction from the CPU 40 to display a game screen (display screen) including a background, an object, etc. on the LCD 14.

The operating portion 42 includes the above-described respective operation buttons 16, 18, 20, 22, 24, 26, 28, and in response to an operation of each of these buttons, an operation input signal (or operation input data) is applied to the CPU 40. Accordingly, the CPU 40 executes a processing according to the instruction by the player (user) applied through the operating portion 42.

The WRAM 44 is a writable/readable memory, and is utilized as a working area or a buffer area of the CPU 40. The transmitting/receiving buffer 48 is, for example, for temporarily storing transmitting/receiving data during a communication play of a multiplayer game, and connected to an external expansion connector 52. By connecting another game apparatus 10 (game machine 12) to the connector 52 with the use of a communication cable not shown, it becomes possible to perform data communications among a plurality of game apparatuses 10.

A sound control circuit 50 is connected to the above-described respective speakers 34L and 34R. The sound control circuit 50 converts a sound signal being a digital applied from the CPU 40 into a sound signal (L channel sound signal and R channel sound signal) being an analog so as to be output from the speaker 34L and the speaker 34R. Accordingly, a sound required for the game is output. Also, the sound control circuit 50 adjusts a volume of a sound to be output according to an instruction from the CPU 40, and echoes the sound to be output.

The game cartridge 32 is integrated with a ROM 54 and a RAM 56, and the ROM 54 and the RAM 56 are connected with each other via a bus, and connected to a connector 58. Therefore, when the game cartridge 32 is loaded into the game machine 12 to connect the connector 46 and the connector 58 as described above, the CPU 40 is electrically connected to the ROM 54 and the RAM 56. This allows the CPU 40 to read out predetermined program data from a predetermined area of the ROM 54 to develop it in the WRAM 44, read out predetermined backup data to write it in the WRAM 44, write to a predetermined area in the RAM 56 the game data, and so on generated in correspondence to the progress of the game in the WRAM 44 to store it, and so forth.

It is noted that although a flash memory being a non-volatile memory is employed as the RAM 56, another non-volatile memory such as a ferroelectric memory (FeRAM), an EEPROM, etc. can also be applied. Also, an SRAM, a DRAM, etc. that use a battery as a power may be utilized.

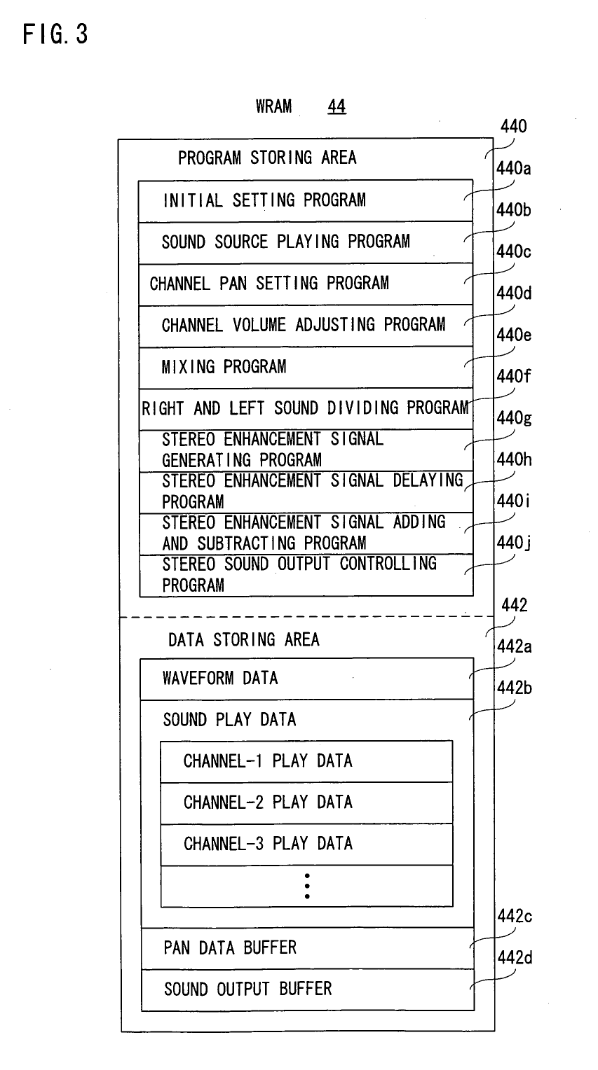

FIG. 3 is an illustrative view showing one example of a memory map of the WRAM 44. It is noted that only the program (sound playing program) and data, etc. required for outputting a voice (sound) are shown in FIG. 3, and the program and data, etc. required for the game except for the sound reproduction are omitted in FIG. 3. Referring to FIG. 3, the WRAM 44 includes a program storing area 440 and a game data storing area 442. The program storing area 440 stores a sound playing program including a stereo enhancement processing program. The sound playing program consists of a initial setting program 440a, a sound source playing program 440b, a channel pan setting program 440c, a channel volume adjusting program 440d, a mixing program 440e, a right and left sound dividing program 440f, a stereo enhancement signal generating program 440g, a stereo enhancement signal delaying program 440h, a stereo enhancement signal adding and subtracting program 440i, and a stereo sound output controlling program 440j, etc.

The initial setting program 440a is a program for setting an initial value of the operating portion 42 (operation buttons 16, 18, 20, 22, 24, 26, 28), pan of sounds as to sounds (stereo sound, in this embodiment) output from sound sources of a plurality of channels (16 channels in this embodiment) and initial values of volumes of the stereo sounds, and initializing buffers (442c, 442d) to be described later. The sound source playing program 440b is a program for playing a sound according to music data of sound play data 442b by use of waveform data 442a to be described later. The channel pan setting program 440c is a program for setting the pan of the sounds by adjusting between the right and the left a balance of the stereo sounds output from the respective sound sources. This is for allowing a game character (sound object, for example) to move on a game screen according to an operation by the player or processing by the computer (CPU 40), allowing a position of a channel (sound source) corresponding to the game character to be changed, and also allowing the pan of the sound to be changed.

The channel volume adjusting program 440d is a program for adjusting volumes of the respective stereo sounds output from sound sources on the basis of the pan of the sounds as to the stereo sounds output from the sound sources according to the channel pan setting program 440c. The volume adjustment will be described in detail later, and therefore, a detailed description is omitted here. The mixing program 440e is a program for mixing outputs from the respective sound sources whose volumes have been adjusted according to the channel volume adjusting program 440d to obtain a stereo output of the two channels. That is, the mixing program 440e is for bring together the plurality of stereo sounds to be simultaneously played into one stereo sound.

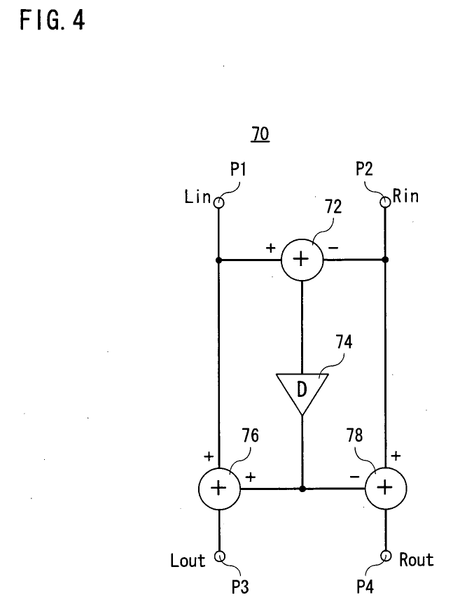

The right and left sound dividing program 440f is a program for dividing the mixed stereo output, that is, an L channel sound signal and an R channel sound signal into two systems. As described later, the L channel sound signal and the R channel sound signal are directly utilized for a sound output, and also utilized for generating a stereo enhancement signal (see FIG. 4). The stereo enhancement signal generating program 440g is a program for generating a stereo enhancement signal. More specifically, the stereo enhancement signal is generated with the use of the L channel sound signal and the R channel sound signal divided by the right and left sound dividing program 440f. More specifically, the stereo enhancement signal (crosstalk cancel signal) is generated by subtracting the L channel sound signal from the R channel sound signal, and vice versa. In this embodiment, the R channel sound signal (Rin) is subtracted from the L channel sound signal (Lin) (see FIG. 4).

The stereo enhancement signal delaying program 440h delays the stereo enhancement signal generated according to the stereo enhancement signal generating program 440g by a predetermined time period. Here, the predetermined time period is set in advance depending on an arrangement space (distance) between the two speakers (34L, 34R, in this embodiment). The stereo enhancement signal adding and subtracting program 440i is a program for adding the stereo enhancement signal (delay stereo enhancement signal) delayed by the stereo enhancement signal delaying program 440h to a sound signal out of the L channel sound signal and the R channel sound signal on the subtracted side when generating the stereo enhancement signal, and subtracting it from a sound signal on the subtracting side when generating the stereo enhancement signal. As described above, in this embodiment, the stereo enhancement signal is generated by subtracting the R channel sound signal from the L channel sound signal, and therefore, the delay stereo enhancement signal is added to the L channel sound signal, and subtracted from the R channel sound signal.

The stereo sound output controlling program 440j is a program for outputting the sound signal on which an addition and a subtraction are performed through the stereo enhancement signal adding and subtracting program 440i as a stereo sound from the speakers 34L and 34R. In this embodiment, a stereo sound is output, wherein a signal obtained by adding the delay stereo enhancement signal to the L channel sound signal according to the stereo enhancement signal adding and subtracting program 440i (added signal) is regarded as an L channel of the stereo sound, and a signal obtained by subtracting the delay stereo enhancement signal from the R channel sound signal according to the stereo enhancement signal adding and subtracting program 440i (subtracted signal) is regarded as an R channel of the stereo sound.

A data storing area 442 stores waveform data 442a, and music play data 442b, etc. Furthermore, the data storing area 442 is provided with buffer areas such as a pan data buffer 442c, a sound output buffer 442d, etc.

The waveform data 442a is a plurality of data (tone data) for playing the sound sources. Examples are tone data for each part of musical instrument, and tone data of an orchestra. The music play data 442b is play data for each of channels (channel-1 play data, channel-2 play data, channel-3 play data, . . . ), and each of the play data is musical score data. The musical score data consists of a plurality of musical note data.

The pan data buffer 442c is an area for storing (temporarily storing) the pan of the respective channels set in accordance with the channel pan setting program 440c. The sound output buffer 442d is utilized as a working area or a buffer area of the CPU 40 shown in FIG. 2, and stores a sound signal to be used or to be generated in a case that each of the mixing program 440e, the right and left sound dividing program 440f, the stereo enhancement signal generating program 440g, the stereo enhancement signal delaying program 440h, and the stereo enhancement signal adding and subtracting program 440i is executed.

In the game apparatus 10 with such a configuration, a sound required for the game (stereo sound) is output from the speaker 34L and the speaker 34R during the game in order to represent depth of the virtual game space and realism of the game. For this purpose, it is necessary that the sound signal output from the speaker 34L reaches a left ear of the player, and the sound signal output from the speaker 34R reaches a right ear of the player. However, actually, the sound signal output from the speaker 34L reaches the right ear of the player, and the sound signal output from the speaker 34R reaches a left ear of the player. So called a crosstalk occurs.

An eliminating (canceling) method of such a crosstalk has already been known. However, use of a general crosstalk cancel circuit causes a disadvantage of reducing the sound quality of sounds positioned at an approximately center. In the crosstalk cancel circuit improved in such the disadvantage, sounds positioned at an approximately center are not subjected to be the crosstalk cancel.

On the other hand, a stereo sound signal (left signal and right signal) is input, and a signal obtained by taking a difference between the left signal and the right signal is subjected to a filter process. A delayed signal through the filter process is added to one of the stereo sound signal, and is subtracted from the other of the stereo sound signal. Thus, this may be another method of obtaining the sound output with sound enhanced.

In the former method, it is possible to prevent sound quality of the sound positioned at a center from being reduced. However, in a case that sounds are simultaneously played from a plurality of sound sources like the game apparatus 10, a crosstalk cancel process is individually performed on each of the sound output from each of the sound sources. Thus, when crosstalk cancel is performed in terms of the software, a processing load (cost required for the process) is increased. In addition, in the latter, a delay process depending on frequencies needs to perform a filter process, increasing a processing load similar to the former. Accordingly, a direct application of such a processing to the game apparatus 10 affects execution of game processes except for the sound output. In addition, in a case that the above-described process is executed in terms of the hardware, the size of the circuit is large, and the game apparatus 10 itself is complicated and expensive. That is, it is not appropriate to apply it to the game apparatus 10.

Here, in this embodiment, it is possible to enhance with a simple process a stereo sound by canceling the crosstalk without reducing sound quality of a sound positioned at the center. A detailed description is made below.

FIG. 4 is a circuit diagram showing a functional configuration (circuit 70) of the stereo enhancement process in this embodiment. Referring to FIG. 4, in the circuit 70, an L channel sound signal (Lin) is input to an input terminal P1, and an R channel sound signal (Rin) is input to an input terminal P2. It is noted that the L channel sound signal and the R channel sound signal are a stereo output (one stereo sound) obtained by mixing stereo sounds simultaneously played from all (a plurality of) sound sources for playing sounds.

The L channel sound signal is directly input to each of an adder 72 and an adder 76. That is, the L channel sound signal is divided into two systems. On the other hand, the R channel sound signal is inversely input to the adder 72, and is directly input to an adder 78. That is, the R channel sound signal is also divided into two systems. In the adder 72, the input L channel sound signal and the inversely input R channel sound signal are added. That is, the R channel sound signal is subtracted from the L channel sound signal to generate a stereo enhancement signal (Lin−Rin). An output signal from the adder 72, that is, a stereo enhancement signal is delayed by a delay circuit 74, and a delayed stereo enhancement signal (delay stereo enhancement signal) is input to the adder 76 and inversely input to the adder 78.

In the adder 76, the L channel sound signal and the delay stereo enhancement signal (Lin−Rin)′ (“′” means delay) are added. Furthermore, in the adder 78, the R channel sound signal and the delay stereo enhancement signal inversely input are added. That is, the delay stereo enhancement signal is subtracted from the R channel sound signal. The output signal from the adder 76, that is, the signal obtained by adding the L channel sound signal and the delay stereo enhancement signal (added signal: Lin+(Lin−Rin)′) is output from an output terminal P3 as an L channel sound signal (Lout). Furthermore, the output signal from the adder 78, that is, the signal obtained by subtracting the delay stereo enhancement signal from the R channel sound signal (subtraction signal: Rin−(Lin−Rin)′) is output from an output terminal P4 as an R channel sound signal (Rout).

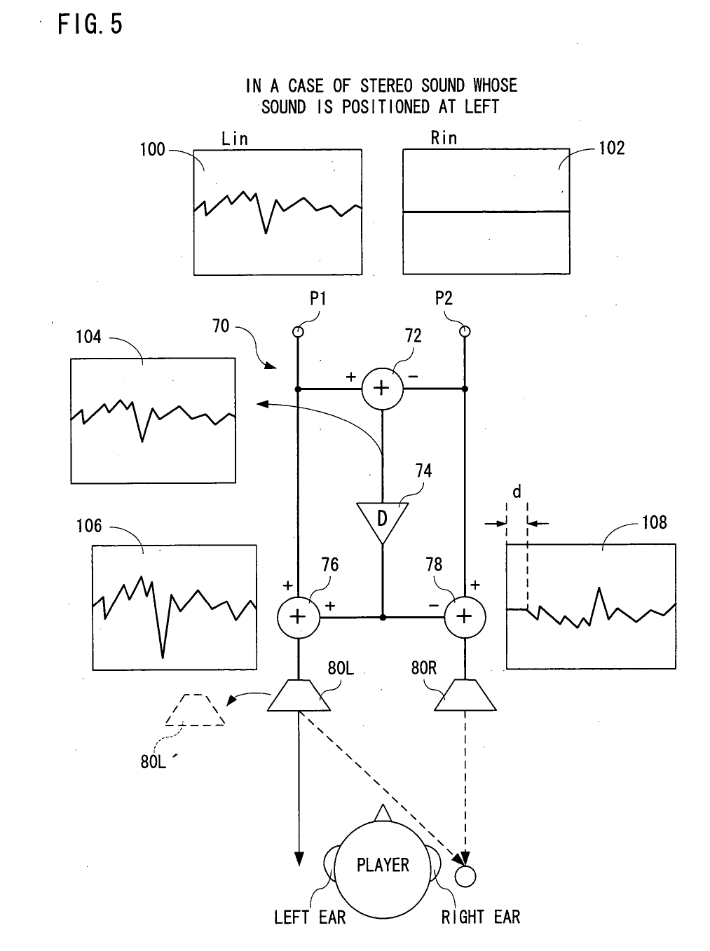

For example, as shown in FIG. 5, in a case of a sound (stereo sound) whose sound is positioned at the left, for example, assuming that the L channel sound signal (Lin) shown by a waveform 100 is input to the input terminal P1, and the R channel sound signal (Rin) shown by a waveform 102 is input to the input terminal P2. In addition, in the circuit 70 shown in FIG. 5, a speaker 80L (is equal to 34L in FIG. 1, FIG. 2) is provided in place of the output terminal P3, and an speaker 80R (equal to 34R in FIG. 1, FIG. 2) is provided in place of the output terminal P4.

As described above, in the adder 72, the stereo enhancement signal is generated and output. The stereo enhancement signal is shown by a waveform 104. That is, the inverted waveform 102 is subtracted from the waveform 100 to generate the waveform 104. The stereo enhancement signal shown by such the waveform 104 is delayed by the delay circuit 74, then input to the adder 76, and inversely input to the adder 78. Accordingly, in the adder 76, an added signal shown by a waveform 106 is generated, and output from the speaker 80L. In addition, in the adder 78, a subtracted signal shown by a waveform 108 is generated, and output from the speaker 80R. Here, a time period d of the waveform 108 corresponds to a predetermined time period during which the stereo enhancement signal is delayed by the delay circuit 74. Accordingly, a crosstalk component of the sound signal output from the speaker 80L is cancelled by the sound signal output from the speaker 80R to lower the volume of the crosstalk component. Therefore, the player can listen to the sound signal in an extended manner as it the speaker 80L exists at a position of the speaker 80L′. That is, the stereo sound is enhanced.

It is noted that similar to the sound signal output from the speaker 80L (34L) shown in FIG. 5, the delayed waveform 100 is added to the waveform 100 in the delay circuit 74, which works as comb filter, and may reduce a sound quality. However, when the delay in the delay circuit 74 (a space between the speaker 34L and the speaker 34R is in the order of 10.5 cm, and the predetermined time period to be delayed shall be 0.0625 ms in this embodiment) is much smaller, a frequency at which an influence of comb filter occurs becomes higher (in the order of 8 kHz in this embodiment), exerting less influence on the sound quality. Accordingly, it is not necessary to adjust sound quality by a filter, etc. Although illustration is omitted, in a case of a sound (stereo sound) positioned at the right, in contrast to a case where the sound is positioned at the left shown in FIG. 5, a sound can be heard as if the speaker 80R exists at a position diverted to the right, and the stereo sound can be heard in an extended manner. That is, the stereo sound is enhanced.

Thus, it is possible to localize the sound of the stereo sound outsides the speaker 80L and the speaker 80R. Accordingly, if the outputs from the adder 76 and the adder 78 are respectively applied to the speaker 34L and the speaker 34R provided to the game apparatus 10, it is possible to hear a sound required for the game spaciously.

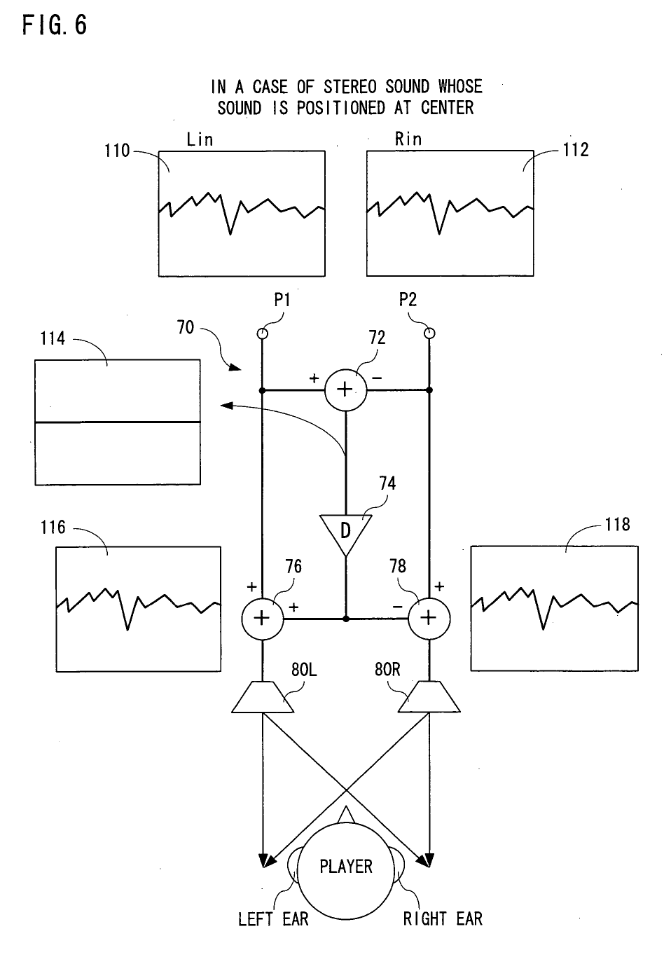

In addition, as shown in FIG. 6, in a case of a sound (stereo sound) whose sound is positioned at the center, for example, assuming that the L channel sound signal (Lin) shown by a waveform 110 is input to the input terminal P1, and the R channel sound signal (Rin) shown by a waveform 112 is input to the input terminal P2. However, the waveform 110 and the waveform 112 are the same. It is noted that in FIG. 6 also, in place of the output terminal P3 and the output terminal P4, the speaker 80L and the speaker 80R are provided similar to a case in FIG. 5.

In the adder 72, the R channel sound signal is subtracted from the L channel sound signal to generate and output a stereo enhancement signal shown by a waveform 114. That is, the stereo enhancement signal is ±0. Accordingly, this is equal to a state of no output from the adder 72. Thus, the input L channel sound signal is directly output from the adder 76, and the input R channel sound signal is also directly output from the adder 78. Therefore, the stereo sound positioned at the center can be heard as an original sound positioned at the center, and therefore, being free from reduction in sound quality.

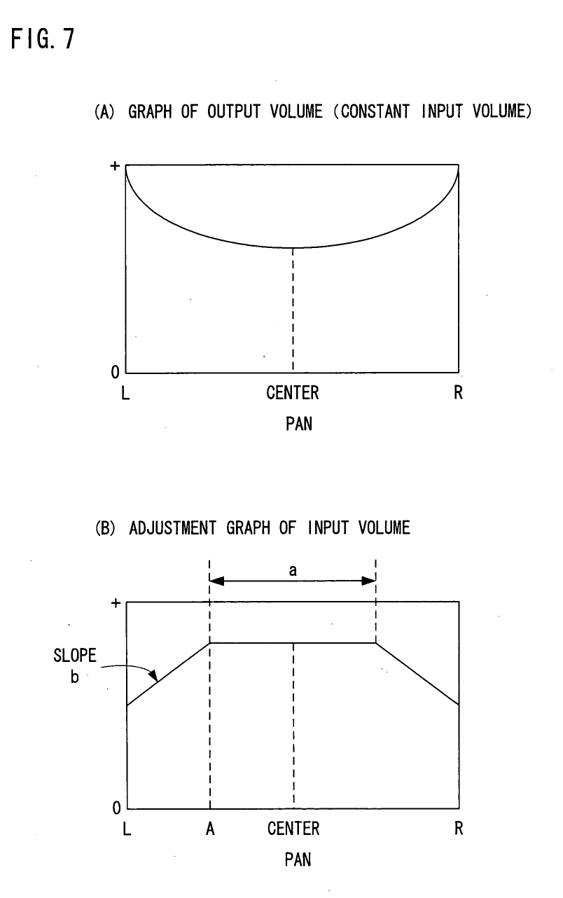

Here, as shown in FIG. 7(A), in a case that a volume of the input stereo sound is constant, a stereo sound to be output (played) becomes large as the pan of the sound moves (is deviated) from the center to the right or the left. Accordingly, without addressing the problem, variations occurs to the volumes of the respective stereo sounds depending on the pan of the respective stereo sounds output from the respective sound sources. The player who listens to a stereo sound obtained by performing a stereo enhancement process on the stereo sound obtained by mixing the respective stereo sounds may have an uncomfortable feeling.

Therefore, in this embodiment, before mixing, the stereo sounds to be played from the respective sound sources are adjusted on the basis of the pan of the sounds, and the respective stereo sounds with adjusted volumes are subjected to mixing.

More specifically, according to an adjustment graph shown in FIG. 7(B), a volume of a stereo sound played by a sound source is adjusted. As shown in FIG. 7(B), in a case that the pan of the stereo sound is set to be within a fixed range “a” including the center, the volume of the stereo sound is not adjusted (modified). However, in a case that the pan of the sound of the stereo sound is set to be outside the fixed range “a”, the volume of the stereo sound is adjusted such that the volume is linearly small as the pan of the sound moves to the outside. It is noted that the center of the fixed range “a” is equal to the center of the pan.

It is noted that in a case that the pan of the sound of the stereo sound is set to be outside the fixed range “a” in this embodiment, the adjustment of the volume of the stereo sound is executed according to an arithmetic operation according to an equation 1. More specifically, the arithmetic operation according to the equation 1 is made by executing the channel volume adjusting program 440d shown in FIG. 3.
adjusted volume=volume to be adjusted×(1−a)
α=slope b×bias (0≦α≦1) [Equation 1]

However, in the equation 1, “a” is an attenuated amount of the sound, and the bias is a distracted amount of the pan from “A” to “L” direction (to left side).

It is noted that in a case that the pan of the sound of the stereo sound is set to be outside the fixed range “a”, and distracted to the R direction (right side), the adjusted volume can be calculated by use of the bias (distracted amount) and an absolute value of the slope according to the equation 1.

As described above, in this embodiment, the fixed range “a” has ranges of some extent, and furthermore, the adjustment can be changed by varying the fixed range “a” and the slope “b”.

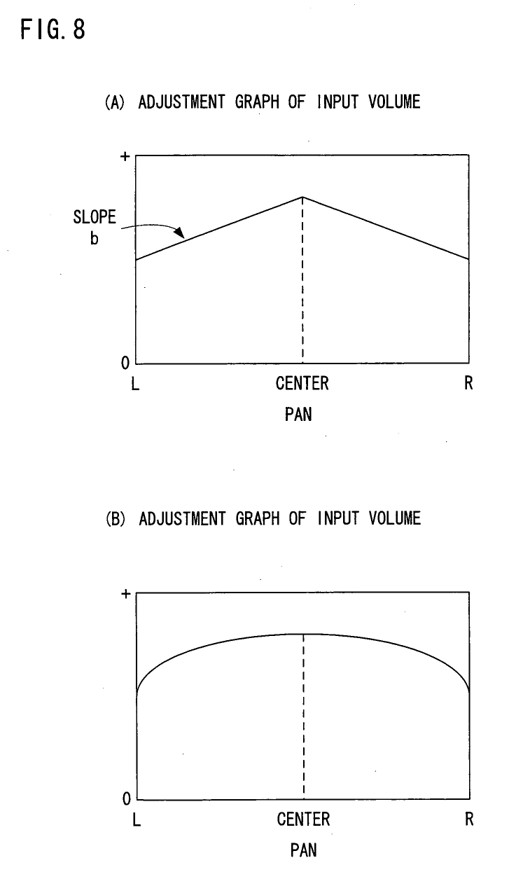

It is noted that as shown in FIG. 8 (A), the volume of the stereo sound can be adjusted such that the volume becomes small without the fixed range “a” along with the line represented by the slope “b” as the pan is away from the center. In this case, only when the pan exists at the center, the volume of the stereo sound is not adjusted.

In addition, as shown in FIG. 7 (A), taking a characteristic of a sound output where the volume of the input sound is constant into consideration, for example, as shown in FIG. 8 (B), the volume may be adjusted in accordance with a quadratic curve (having a pivot at the center pan, and releasing downward). In such a case also, as shown in FIG. 8 (A), only when the pan exists at the center, the volume of the stereo sound is not adjusted, and the volume of the stereo sound is adjusted such that the volume of the stereo sound is made small as the pan is away from the center.

In addition, in this embodiment, in a case that the pan of the sound of the stereo sound is set outside the fixed range “a”, the adjusted volume is calculated according to the pan. However, adjusted volumes corresponding to the pan are calculated in advance, and a table on which the adjusted volumes corresponding to the pan are described is stored, and whereby, according to the table, an adjusted volume can be evaluated. In such a case, by executing the channel volume adjusting program 440d, the adjusted volume according to the pan of each of the channels is fetched from the table.

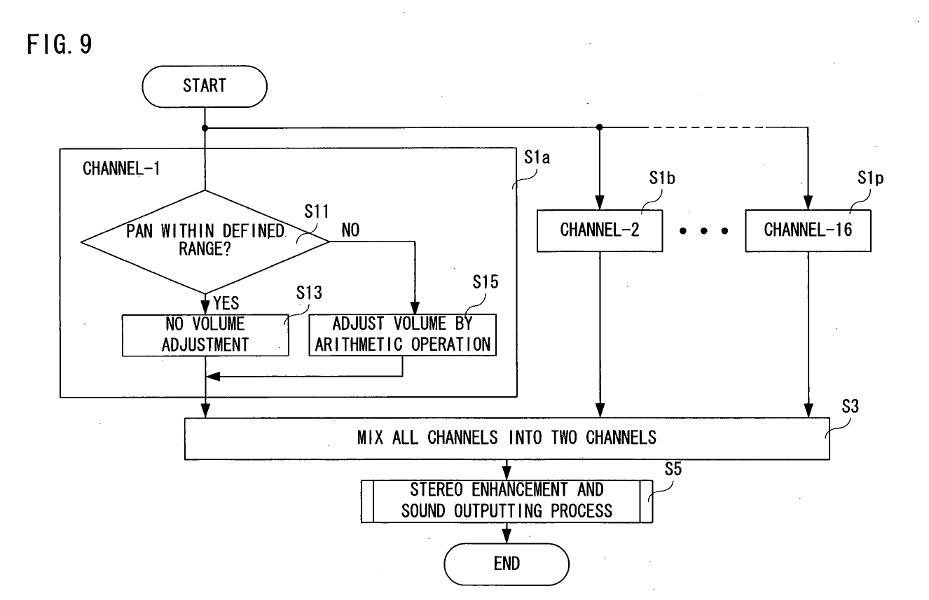

More specifically, the CPU 40 shown in FIG. 2 executes a flowchart of the sound playing process shown in FIG. 9. It is noted that although illustration is omitted, the sound playing process is executed according to a timing determined by a programmer and a developer of the game in advance or according to an operation timing by the player.

Referring to FIG. 9, when the sound playing process is started, in steps S1a, S1b, . . . , S1p, a process as to each of the channels is executed. In the game apparatus 10 of this embodiment, sound sources (channels) of 16 are provided, and a process as to each of the sound sources is executed. More specifically, as to channel-1, it is determined whether or not the pan of the channel (channel-1, here) is within a predetermined range (fixed range “a”) in a step S11. If “YES” in the step S11, that is, if the pan is within the fixed range “a”, without performing a volume adjustment (modification) in a step S13, the process proceeds to a step S3. However, if “NO” in the step S11, that is, if the pan is outside the fixed range “a”, a volume is adjusted depending on the pan by the arithmetic operation in a step S15, and then, the process proceeds to the step S3. In the step S15, as described above, an adjusted volume is calculated according to the equation 1. Thus, the process shown in the steps S11-S15 is performed on each of the channels, stereo sounds with volumes adjusted as to the respective channels are output.

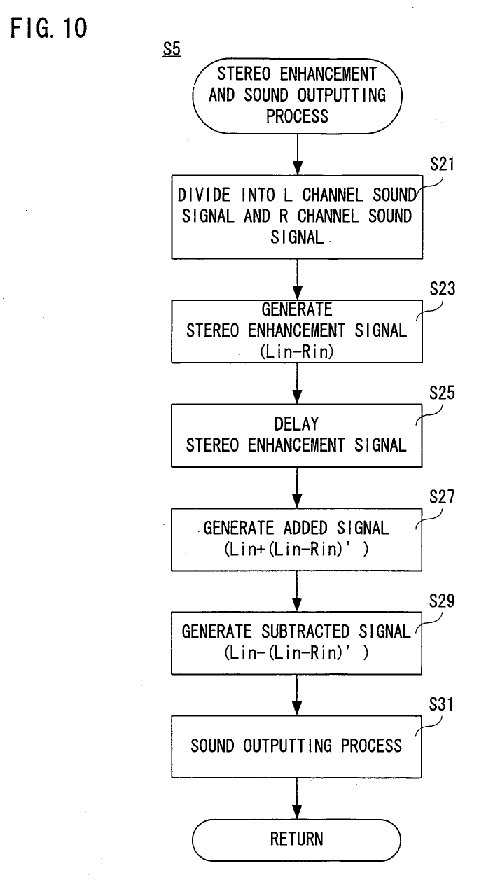

In the step S3, the stereo sounds output (simultaneously played) from the respective channels are mixed into a stereo sound of two channels. Then, in a step S5, a stereo enhancement and sound outputting process (see FIG. 10) described later is executed, and then, the sound playing process is ended.

It is noted that in this embodiment, in a case that the pan of the sound exists within the fixed range “a”, the sound adjustment is not performed in the step S13 for simplicity, but no process is actually performed in the step S13.

FIG. 10 is a flowchart for showing a stereo enhancement and sound outputting process. Referring to FIG. 10, when the CPU 40 starts to perform the stereo enhancement and sound outputting process, the sound output obtained by mixing the stereo sounds, that is, an L channel sound signal (Lin) and an R channel sound signal (Rin) is divided into two systems in a step S21. In a following step S23, a stereo enhancement signal (Lin−Rin) is generated. Then, the stereo enhancement signal is delayed in a step S25, an added signal (Lin+(Lin−Rin)′) is generated in a step S27, and a subtracted signal (Rin-(Lin−Rin)′) is generated in a step S29. It is noted that (Lin−Rin)′ is a delay stereo enhancement signal. Then, in a step S31, a sound playing process is executed, returning from the stereo enhancement and sound outputting process. In the step S31, the added signal is output from the speaker 34L for L channel, and the subtracted signal is output from the speaker 34R for R channel via the sound control circuit 50.

It is noted that in the step S31, the added signal is output to the sound control circuit 50 (FIG. 2) as an L channel sound signal, and the subtracted signal is output to the sound control circuit 50 as an R channel sound signal. Accordingly, a game music (sound) of the stereo sound is output from the speaker 34L and the speaker 34R.

According to this embodiment, stereo sounds output from the plurality of sound sources are mixed into a stereo sound of two channels, and the stereo enhancement process is performed on the mixed stereo sound, capable of decreasing a processing load. That is, it is possible to substantially reduce a cost required for processing.

In addition, according to this embodiment, the volumes of the respective stereo sounds output from the respective sound sources are adjusted on the basis of the pan, and therefore, variations does not occur to the volumes of the sound sources depending on the pan, and thus, enhancement of the sound of the mixed stereo sound does not cause an uncomfortable feeling. That is, it is possible to listen to the game sound or the game music with reality.

Furthermore, according to this embodiment, the stereo enhancement signal is generated by subtracting the sound signal of one channel from the sound signal of the other channel out of the mixed stereo sound, and therefore, it is possible to prevent sound quality of the stereo sound positioned at approximately the center from being reduced.

It is noted that in the above-described embodiment, a description is made on the hand-held type game apparatus, but this is not limited thereto. For example, this is applicable to a video game apparatus for home, a mobile phone having a game function, etc.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing a stereo enhancement processing program causing a stereo sound playing apparatus provided with a plurality of sound sources for respectively generating a plurality of stereo sounds to be simultaneously played and speakers for outputting a stereo sound to function as a stereo enhancement apparatus, said stereo enhancement processing program causes a processor of said stereo sound playing apparatus to execute:
a pan setting step of setting pan of sounds by adjusting a balance between the right and the left as to respective one of said plurality of stereo sounds;
a volume adjusting step of adjusting volumes of said stereo sounds output from said sound sources on the basis of said pan set by said pan setting step;
a mixing step of mixing the plurality of stereo sounds whose volumes have been adjusted by said volume adjusting step to make a stereo output of two channels; and
a stereo enhancement step of enhancing a sound of said stereo output which has been mixed by said mixing step.

2. A storage medium storing a stereo enhancement processing program according to claim 1, wherein
said stereo enhancement step includes a stereo enhancement signal generating step of generating a stereo enhancement signal by subtracting a sound signal of one channel from a sound signal of the other channel out of said stereo output by said mixing step, a delaying step of generating a delay stereo enhancement signal obtained by delaying said stereo enhancement signal, an adding step of generating an added signal by adding said delay stereo enhancement signal to said sound signal of said other channel, a subtracting step of generating an subtracted signal obtained by subtracting said delay stereo enhancement signal from said sound signal of said one channel, and a sound outputting step of making a sound output by taking said added signal as said stereo output of the one channel and said subtracted signal as said stereo output of the other channel.

3. A storage medium storing a stereo enhancement processing program according to claim 1, wherein
said volume adjusting step does not adjust the volume of said stereo sound when the pan of the sound of said stereo sound output from said sound source exists within a fixed range including a center, and adjusts, when the pan of the sound of said stereo sound output from said sound source exists outside the fixed range, the volume of said stereo sound such that the volume is lowered as it is away from said fixed range.

4. A storage medium storing a stereo enhancement processing program according to claim 1, wherein
said volume adjusting step does not adjust the volume of said stereo sound when the pan of the sound of said stereo sound output from said sound source exists at the center, and adjusts, when the pan of the sound of said stereo sound output from said sound source exists in a position except for the center, the volume of said stereo sound such that the volume is lowered as it is away from the center.

5. A stereo enhancement apparatus, comprising:
a plurality of sound sources for respectively generating a plurality of stereo sounds to be simultaneously played;
a pan setting means for setting pan of sounds by adjusting a balance between the right and the left as to respective one of said plurality of stereo sounds;
a volume adjusting means for adjusting volumes of said stereo sounds output from said sound sources on the basis of said pan set by said pan setting means;
a mixing means for mixing the plurality of stereo sounds whose volumes have been adjusted by said volume adjusting means to make a stereo sound of two channels; and
a stereo enhancement means for enhancing a sound of said stereo output which has been mixed by said mixing means.

6. A stereo enhancement apparatus according to claim 5, wherein
said stereo enhancement means includes a stereo enhancement signal generating means for generating a stereo enhancement signal by subtracting a sound signal of one channel from a sound signal of the other channel out of said stereo output by said mixing means, a delaying means for generating a delay stereo enhancement signal obtained by delaying said stereo enhancement signal, an adding means for generating an added signal by adding said delay stereo enhancement signal to said sound signal of said other channel, a subtracting means for generating a subtracted signal obtained by subtracting said delay stereo enhancement signal from said sound signal of said one channel, and a sound outputting means for making a sound output by taking said added signal as said stereo output of said one channel and said subtracted signal as said stereo output of said other channel.

7. A stereo enhancement apparatus according to claim 5, wherein
said volume adjusting means does not adjust the volume of said stereo sound when the pan of the sound of said stereo sound output from said sound source exists within a fixed range including a center, and adjusts, when the pan of the sound of said stereo sound output from said sound source exists outside the fixed range, the volume of said stereo sound such that the volume is lowered as it is away from said fixed range.

8. A stereo enhancement apparatus according to claim 5, wherein
said volume adjusting means does not adjust the volume of said stereo sound when the pan of the sound of said stereo sound output from said sound source exists at the center, and adjusts, when the pan of the sound of said stereo sound output from said sound source exists in a position except for the center, the volume of said stereo sound such that the volume is lowered as it is away from the center.

9. A stereo enhancement method of a stereo sound playing apparatus provided with sound sources for respectively generating a plurality of stereo sounds to be simultaneously played and speakers for outputting a stereo sound, comprising following steps of
(a) setting pan of sounds by adjusting a balance between the right and the left as to respective one of said plurality of stereo sounds,
(b) adjusting volumes of said stereo sounds output from said sound sources on the basis of said pan set by said step (a),
(c) mixing the plurality of stereo sounds whose volumes have been adjusted by said step (b) to make a stereo output of two channels; and
(d) enhancing a sound of said stereo output which has been mixed by said step (c).

10. A stereo enhancement method according to claim 9, wherein
said step (d) includes a step (d-1) of generating a stereo enhancement signal by subtracting a sound signal of one channel from a sound signal of the other channel out of said stereo output by said step (c), a step (d-2) of generating a delay stereo enhancement signal obtained by delaying said stereo enhancement signal, a step (d-3) of generating an added signal by adding said delay stereo enhancement signal to said sound signal of said other channel, a step (d-4) of generating an subtracted signal obtained by subtracting said delay stereo enhancement signal from said sound signal of said one channel, and a step (d-5) of making a sound output by taking said added signal as said stereo output of said one channel and said subtracted signal as said stereo output of said other channel.

11. A stereo enhancement method according to claim 9, wherein
said step (b) does not adjust the volume of said stereo sound when the pan of the sound of said stereo sound output from said sound source exists within a fixed range including the center, and adjusts, when the pan of the sound of said stereo sound output from said sound source exists outside the fixed range, the volume of said stereo sound such that the volume is lowered as it is away from said fixed range.

12. A stereo enhancement method according to claim 9, wherein
said step (b) does not adjust the volume of said stereo sound when the pan of the sound of said stereo sound output from said sound source exists at the center, and adjusts, when the pan of the sound of said stereo sound output from said sound source exists in a position except for the center, the volume of said stereo sound such that the volume is lowered as it is away from the center.
